(19) United States
(12) Patent Application Publication
(10) Pub. No.: US 2024/0131794 A1
(43) Pub. Date: Apr. 25, 2024

(54) 3D Printed Meshes For Filters Based on Digitally Designed Lattice-Based Cellular Microarchitectures

(71) Applicants: Jose DOMINGUEZ, Cambridge, MA (US); Paloma GONZALEZ, Cambridge, MA (US)

(72) Inventors: Jose DOMINGUEZ, Cambridge, MA (US); Paloma GONZALEZ, Cambridge, MA (US)

(21) Appl. No.: 18/486,052

(22) Filed: Oct. 12, 2023

Related U.S. Application Data
(60) Provisional application No. 63/415,490, filed on Oct. 12, 2022.

(51) Int. Cl. B29C 64/386; B29C 64/129

(52) U.S. Cl. CPC B29C 64/386; B29C 64/129; B33Y 10/00

(57) ABSTRACT

Provided herein are methods of manufacturing a mold, wherein the methods comprise: (a) applying one or more input parameters to determine effect on process constraints in making a solid mesh; (b) printing a block of a micro-architected material; (c) determining porosity of the block; (d) determining feasibility of the micro-architected material to print; (e) defining architecture parameters of the mold based on solid mesh input parameters; (f) printing the mold, wherein the feasibility is an ability to print the solid mesh without clogging solid mesh; wherein if the micro-architected material is found not feasible at step (d), the solid mesh input parameters are adjusted and steps (b)-(d) are repeated.

### BACKGROUND

Molded fiber products (MFP's), also known as molded pulp products, have been an industry for over one hundred years. In the last 25 years, after being restricted to egg packaging and boxes, the industry has seen a resurgence as consumers demand alternative materials to single-use plastics. The biodegradable and recyclable feedstock, low cost, and high production rate have made companies embrace these products. However, the expansion of this industry has been slowed by high entry barriers (e.g., high initial investment, high demand), archaic processes, and lack of standardization. The most significant example is the need for modernizing the fabrication process of forming molds, a critical manufacturing component. Accordingly, there is a need to improve productivity and/or efficiency in the field of design and fabrication of molds.

### BRIEF SUMMARY

Provided herein are methods of manufacturing a mold, wherein the methods comprise: (a) applying one or more input parameters to determine effect on process constraints in making a solid mesh; (b) printing a block of a micro-architected material; (c) determine porosity of the block; (d) determine feasibility of the micro-architected material to print; (e) defining architecture parameters of the mold based on solid mesh input parameters; (f) printing the mold, wherein the feasibility is an ability to print the solid mesh without clogging solid mesh; wherein if the micro-architected material is found not feasible at step (d), the solid mesh input parameters are adjusted and steps (b)-(d) are repeated. In some embodiments, the methods further comprise validating functionality of the mold under industrial conditions. In some embodiments, the input parameters comprise unit cell topology, unit cell size, strut diameter, mesh resolution, blend distance, or combinations thereof In some embodiments, the process constraints comprise file size, computation time or combinations thereof.

### BRIEF DESCRIPTION OF THE DRAWINGS

The following drawings form part of the present specification and are included to further demonstrate certain aspects of the present disclosure, which can be better understood by reference to the drawing in combination with the detailed description of specific embodiments presented herein.

FIG. 1 shows exemplary workflow of transfer mold fabrication process.

FIG. 2 shows exemplary workflow of designing and fabricating of 3D printed molds by using micro-architected materials.

FIG. 3 shows geometry of mesh used for determining effect of input parameters by process constrains.

FIGS. 4A-4B shows exemplary CAD drawings. Specifically, FIGS. 4A and 4B shows CAD drawings of Kelvin Unit Cell Topologies and BCC Unit Cell Topologies, respectively.

FIGS. 5A-5H show results of input parameters on process constrains. Specifically, FIGS. 5A-5B show results of influence of unit cell topology on the process constrains. FIGS. 5C-5D shows results of influence of unit cell size on the process constrains. FIGS. 5E-5F show results of influence of mesh resolution on the process constrains. FIGS. 5G-5H show results of influence of blend distance on the process constrains.

FIGS. 6A-6B shows mesh configurations of printed blocks. Specifically, FIG. 6A shows mesh configurations of Kelvin. FIG. 6B shows mesh configuration of BCC.

FIG. 7 shows integrated mold architecture having four components.

FIGS. 8A-8I show workflow and results of printability test. Specifically, FIG. 8A shows CAD file of the mold for printability testing. FIG. 8B shows section analysis of the mold showing intersections and gaps between components. FIGS. 8C-8I show results of printability test.

FIGS. 9A-9C show MFP's superficial quality for industrial test. Specifically, FIG. 9A shows an image of a forming mold. FIG. 9B shows an image of superficial quality after removal of the MFP from the forming mold. FIG. 9C shows an image of superficial quality after thermoforming process.

FIGS. 10A-10C show images of MFP obtained from the IMFA prototyping machine. Specifically, FIG. 10A shows an image of MFP obtained with short fiber. FIG. 10B shows an image of MFP obtained with long fiber. FIG. 10C shows an image of an industrial mold MFP.

FIGS. 11A-11B show images of 3D printed forming and transfer mold quality for industrial test. FIGS. 11C-11D show images of tools used for obtaining MFP results. FIG. 11E shows an image of an assembled mold.

Various aspects now will be described more fully hereinafter. Such aspects may, however, be embodied in many different forms and should not be construed as limited to the embodiments set forth herein; rather, these embodiments are provided so that this disclosure will be thorough and complete, and will fully convey its scope to those skilled in the art.

### DETAILED DESCRIPTION OF THE INVENTION

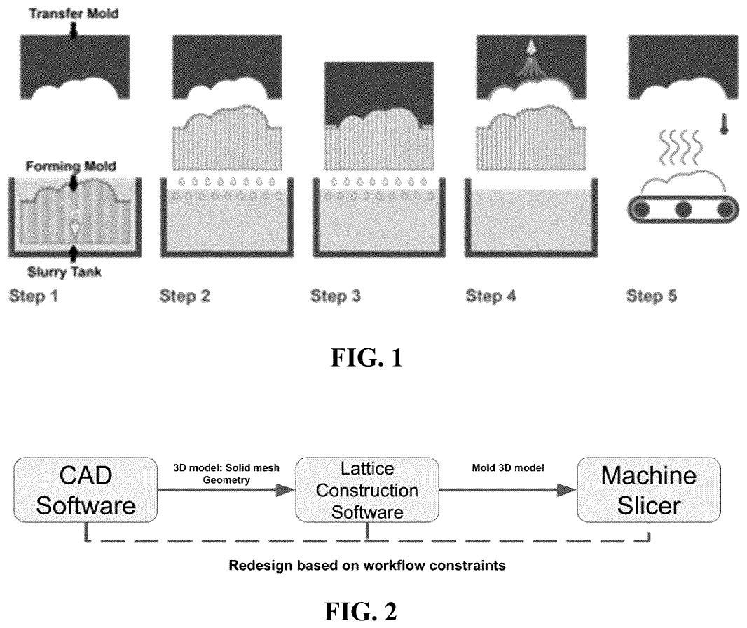

The International Molded Fiber Association (IMFA) has categorized molded fiber production into four main processes. Thick wall, transfer, processed, and thermoformed. All of these processes require a forming mold, which consists of a stainless-steel mesh attached to a metal base-shaped mold perforated with through holes to drain water from a fiber slurry. In some embodiments, the method is the transfer process, consisting of a forming mold and a transfer mold. The workflow of this process is presented in FIG. 1. Transfer molding starts with a forming phase. The forming mold is submerged into the slurry, and the water is pulled down, carrying the fibers toward the mesh. The fibers are retained by the mesh, forming the MFP (FIG. 1, step 1). Next, the MFP is pressed between the transfer and the forming molds, reducing its water content; this step is called the drainage phase, shown in FIG. 1, steps 2 and 3. After a few seconds, the suction changes from the forming mold to the transfer mold, releasing the IVIFP; this step is called transfer phase, as shown in FIG. 1, step 4. Finally, the MFP is released in a conveyor belt FIG. 1, step 5. The conveyor belt takes the MFP into an oven, where it is dried.

In some embodiments, stainless steel meshes are core material for forming molds. The meshes are manually thermoformed wed, cut, and attached to the metal shape base. This process results in long manufacturing lead-time and high initial investment, along with the disadvantages of artisanal methods such as poor quality of the mesh attachment developed by highly specialized workers. Furthermore, these processes result in a high number of injuries to the workforce. Leading the industry to evaluate automation as an alternative solution.

Alternatively, additive manufacturing techniques can reduce the cost and manufacturing lead time of the mold by eliminating the need for attaching screens, multi-axis machines, manual labor, and post-processing work for the molds. However, the manufacturing techniques have not overcome a key challenge, the 3d printed meshes cannot withstand the process's vacuum pressure or the fatigue caused by the industrial processes' pressure oscillation at high frequencies (between steps 1 and 4 presented in FIG. 1).

Another manufacturing technique includes Through Holes, where a thin outer layer is perforated by through holes. The layer is placed over a base-shaped mold that provides more robust support. This concept imitates how current metal molds are made, using two separate components, the mesh and a base structure. Consequently, the mesh is subject to vibrations in the mesh-base interface reducing the tools lifespan. One solution to the challenge is an expensive AM technique (i.e., multi-jet fusion, selective laser sintering), limiting the adoption of this manufacturing method.

Another manufacturing technique includes Alternating Toolpath, which consists of alternating the toolpath for the slices; one without a perimeter and small raster gap, the other with a perimeter and large raster gap. However, this method could not manufacture molds with the strength to withstand the process pressures limiting their lifespan to a few cycles.

Accordingly, provided herein are methods of manufacturing molds. The methods demonstrate the feasibility of manufacturing low-cost, fast production forming molds that can withstand the process mechanical requirements and effectively drain water using affordable AM techniques, stereolithography (SLA). In some embodiments, the methods comprise constructing molds (e.g., fiber filtering meshes) by using micro-architected material for forming lattice structures.

The methods provide a valuable strategy of using lattice geometries to develop molded fiber molds with additive manufacturing methods, beyond replicating the stainless-steel mesh architecture currently used in the 3D printing industry. Lattice geometries expand the actionable domain for mold solutions and take advantage of the mechanical and structural properties present in 3D printed objects. Such development advantageously surpasses the toughness-water drainage tradeoff for printed molds and provides a possibility of longer tools lifespans. In some embodiments, the methods provide a feasible solution for building low-cost tooling using affordable machinery.

### METHODS OF MAKING MICRO-ARCHITECTED MATERIAL

Provided herein are method of making molds using micro-architected materials. In some embodiments, a micro-architected material is capable of forming porous structures. In some embodiments, the micro-architected material is capable of controlling control the flow of fluids due to capillary interactions.

In some embodiments, the micro-architected material comprises a lattice structure. In some embodiments, the lattice structure refers to a cellular, reticulated, truss, or lattice topology made up of many uniform lattice elements (e.g., slender beams or rods) and generated by tessellating a unit cell. In some embodiments, the lattice structure comprises high stiffness, strength-to-weight ratio, and fatigue tolerance relative to non-lattice structure.

In some embodiments, the micro-architected material comprises a combination of materials configured to reach a performance not offered by any individual material. For example, in some embodiments, the method takes advantage of solid material composed of plastic resin and air built up from lattice structures.

In some embodiments, the methods of manufacturing a mold comprise: (a) applying one or more input parameters to determine effect on process constraints in making a solid mesh; (b) printing a block of a micro-architected material; (c) determining porosity of the block; (d) determining feasibility of the micro-architected material to print; (e) defining architecture parameters of the mold based on solid mesh input parameters; and (f) printing the mold; wherein the feasibility of the micro-architected material to print is an ability of to print the solid mesh without clogging mesh; wherein if the micro-architected material is found not feasible at step (d), the method further comprises adjusting the process constraints and repeating steps (b)-(d). In some embodiments, the methods further comprise validating functionality of the mold under industrial conditions.

FIG. 2 illustrates a workflow for designing and fabricating 3D printed molds (e.g., lattice-based meshes) from micro-architected materials. As illustrated, the method can be characterized by iterative design, where CAD software is iteratively used for redesigning a solid mesh based on workflow constraints (e.g., file size, computation time).

### Process Constraints

In some embodiments, the micro-architected material input parameters comprise unit cell topology, unit cell size, strut diameter, mesh resolution, blend distance, or combinations thereof.

A unit cell topology is a lattice topology refers to a connected network of struts. In some embodiments, the lattice topology modifies the Load-carrying capacity, fatigue behavior, water drainage capabilities, or combinations thereof of the micro-architected material and, thereby, the mold. Accordingly, in some embodiments, the unit cell topology is selected by evaluating their structural performance (i.e., fatigue tolerance, stress concentration) and fluid dynamics properties (i.e., water drainage capabilities).

In some embodiments, the unit cell size (e.g., height, length, width, or combinations thereof) modifies compressive strength and mesh porosity of the micro-architected material and, thereby, the mold.

in some embodiments, diameter of strut modifies mesh porosity, fatigue properties, capability to absorb water, or combinations thereof of the micro-architected material and, thereby, the mold.

Mesh resolution refers to a body surface rastered with triangles about the side length. In some embodiments, the mesh resolution modifies structure smoothness, water drainage capabilities, printability, or combinations thereof of the micro-architected material and, thereby, the mold.

Blend distance refers to smooth orientations of adjacent triangles to create more rounded transitions. In some embodiments, the blend distance modifies printability of the micro-architected material.

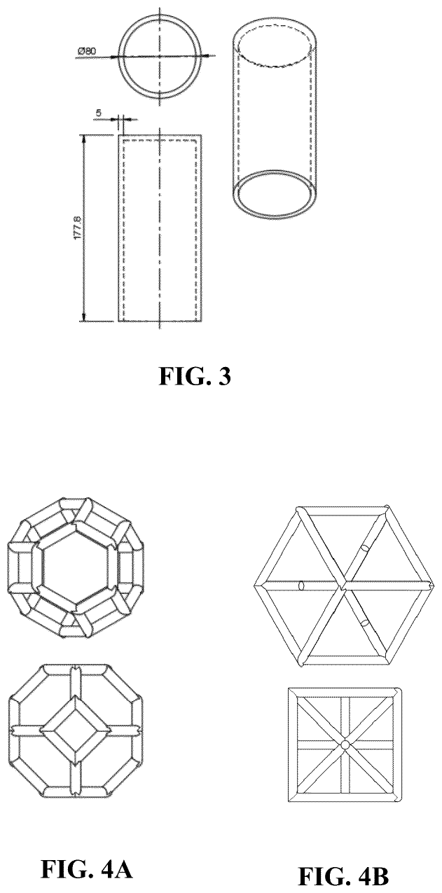

In some embodiments, the input parameters for micro-architected material modify process constraints. In some embodiments, the process constraints comprise file size, computation time or combinations thereof. In some embodiments, effects of the micro-architected material input parameters on the process constraints are determined by converting a cylinder presented in FIG. 3 into a lattice structure varying the input parameters. This 3D model represents the maximum printing volume of a Formlabs Form 3.

### Printability Test

In some embodiments, a printability test is conducted to analyze the relationship between the different components during mold fabrication and define design parameters such as mesh thickness, intersections, and gaps between components.

In some embodiments, the micro-architected material is used for printing a block to perform a printability test. In some embodiments, the printability test comprises: (a) determining porosity of the block; and (b) determining feasibility of the micro-architected material to print. In some embodiments, the micro-architected material is feasible if the micro-architected material does not clog mesh (e.g., due to resin accumulation) during printing of the block.

In some embodiments, the porosity (P) is determined by the ratio difference between the volume of the lattice material (V_{ι}) and the volume of the solid geometry (Vₛ) previous to its conversion into lattice structure. The equation is provided in equation 1:

$$P = 1 - \frac{{V}_{l}}{{V}_{s}} \cdot 100 \qquad ( 1 )$$

### Architecture

In some embodiments, after determining the solid mesh input parameters, design for additive manufacturing techniques is applied for defining architecture parameters of molds. In some embodiments, the methods overcome disadvantages of redefining architecture parameters of the molds, mimicking the architecture parameters of current industry-standard molds, limiting the performance of their tools, or combinations thereof.

In some embodiments, the mold comprises assemblable molds. In some embodiments, the assemblable molds comprise integrated molds. Accordingly, in some embodiments, the mold comprises at least two, at least three, at least four, at least five, at least six, at least seven, at least eight, at least nine, at least ten, at least fifteen, at least twenty, at least twenty-five, at least thirty or at least fifty mold components. In some embodiments, every mold component is individually attached to each other resulting in one integrated rigid body. In some embodiments, the defining of architecture parameters increases the mold's rigidity and fatigue tolerance by reducing the vibration between components. In some embodiments, the defining of architecture parameters increases printability and enhance the mechanical performance of the molds.

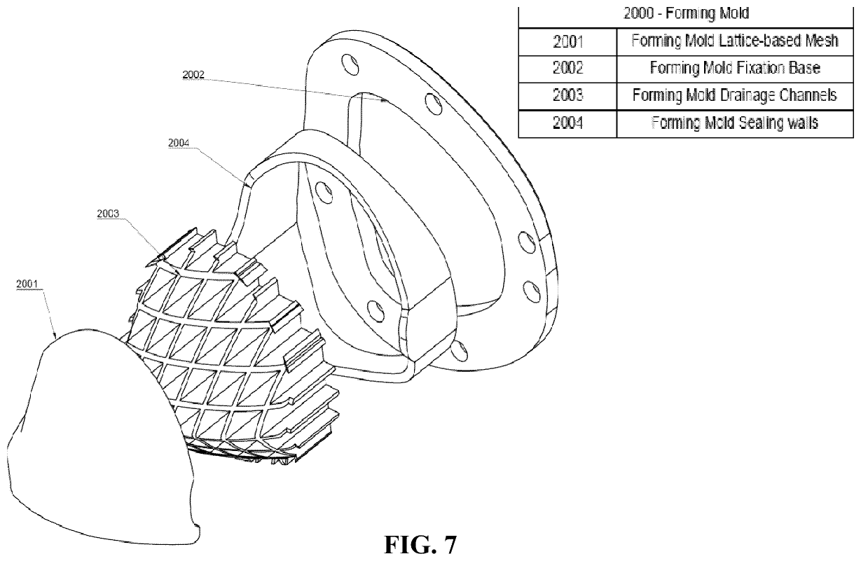

An example of the Integrated Mold architecture is presented in FIG. 7 as a face mask forming mold prototype. Four main components characterize this design; Lattice-based mesh, Drainage channels, Sealing walls, and Fixation base. This architecture is designed with two goals; augmenting the molds' printability and enhancing the lattice-based mesh fatigue tolerance and load-carrying capacity. Lattice-based mesh is a parametric mesh, where the designer can vary the porosity, mechanical performance, and water drainage capabilities based on the parameters such as mesh thickness, intersections, and gaps between components. Drainage channels provides support to the mesh during the printing process. The channel thickness is a crucial parameter for defining the lattice-based mesh's printability, water drainage, uniform suction pressure, and avoiding clogging during the manufacturing process. Sealing walls provide support for the lattice-based mesh and prevent water suction, maintaining the MFP geometry. Fixation base is a base of the mold. The fixation base has through holes that ensure water drainage and holes for fasteners.

### Industrial Validation

In some embodiments, the molds are validated for their functionality under industrial conditions. The parameters of the machine used are presented in TABLE 1.

TABLE 1
MACHINE'S FABRICATION PROCESS PARAMETERS.

| Vacuum pressure | 0.095 [MPa] |
|---|---|
| Blow Off pressure | 0.6 [MPa] |
| Forming time | 1 [s] |
| Drainage time | 6 [s] |
| Cycle frequency (F) | 0.14 |

The vacuum pressure represents the pressure the mesh must withstand during the forming phase (step 1 presented in FIG. 1). The blow-off pressure represents the pressure the mold has to withstand during the transfer phase (step 4 illustrated in FIG. 1).

The forming time shows the time forming phase takes while drainage time indicates the time the water drainage phase takes (steps 2 and 3 in FIG. 1). Finally, the process frequency is determined by equation 2 and represents the number of complete cycles per second. This value allows producers to compare the machine's production rate.

F=1/(|Drainage time+Forming time) (2)

In some embodiments, the validation includes determining the number of cycles the mold is able to withstand the tests. In addition, in some embodiments, the validation includes a qualitative analysis of the superficial quality of the resulting MFP.

### Exemplary Embodiments

Provided herein are methods of manufacturing a mold, wherein the methods comprise: (a) applying one or more input parameters to determine effect on process constraints in making a solid mesh; (b) printing a block of a micro-architected material; (c) determine porosity of the block; (d) determine feasibility of the micro-architected material to print; (e) defining architecture parameters of the mold based on solid mesh input parameters; (f) printing the mold, wherein the feasibility is an ability to print the solid mesh without clogging solid mesh; wherein if the micro-architected material is found not feasible at step (d), the solid mesh input parameters are adjusted and steps (b)-(d) are repeated. Further provided herein are methods, wherein the methods further comprise validating functionality of the mold under industrial conditions. Further provided herein are methods, wherein the input parameters comprise unit cell topology, unit cell size, strut diameter, mesh resolution, blend distance, or combinations thereof. Further provided herein are methods, wherein the process constraints comprise file size, computation time or combinations thereof.

### EXAMPLES

### Example 1

### Characterization of Process Constraints

### Micro Architected Material Input Parameters

The micro-architected materials input parameters were determined, which included unit cell topology, unit cell size, strut diameter, mesh resolution and blend distance. In addition, the unit cell topology was selected by evaluating their structural performance (i.e., fatigue tolerance, stress concentration) and fluid dynamics properties (i.e., water drainage capabilities).

Briefly, Kelvin (FIG. 4A) and BCC (FIG. 4B) unit cell topologies were selected, and mechanical behavior was compared. The comparison indicated that Kelvin structures provide the highest fatigue tolerance and minimum stress concentration for compression. On the other hand, BCC structures demonstrated the capability of absorbing water due to capillary interactions.

### Process Constraints

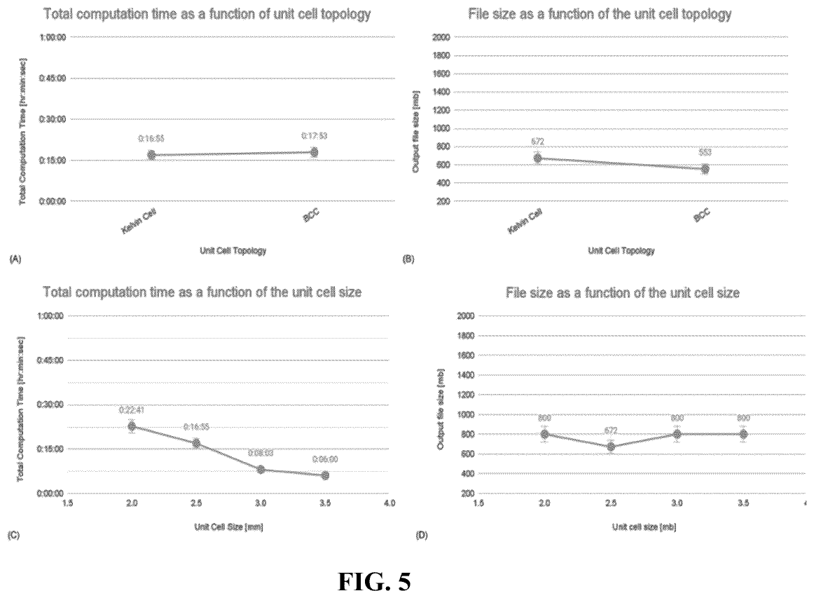

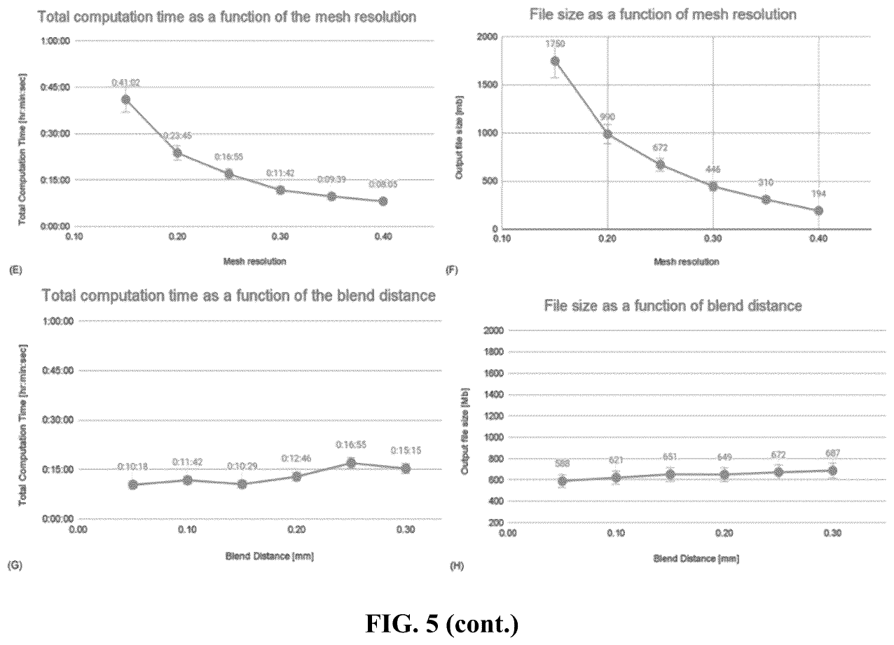

The effect of input parameters on the process constraints were determined to provide optimal performance. FIGS. 5A-51H show that the input parameters with more influence over the process constrains is the mesh resolution (FIGS. 5E and 5F). In addition, the unit cell size was observed to have a significant influence on the computation time (FIGS. 5C and 5D). Additionally, the strut diameter was observed to have influence on the computation time and output file size (not shown).

### Printability Test

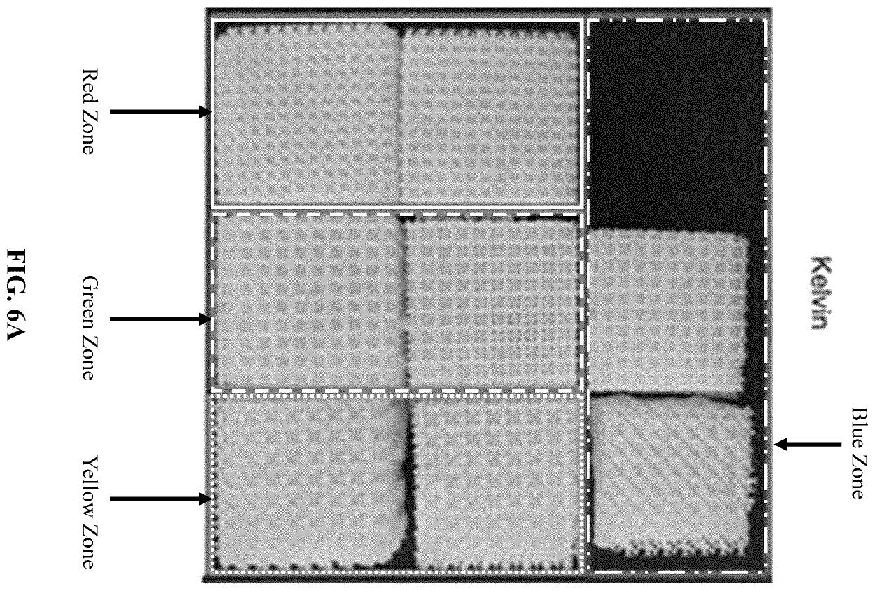

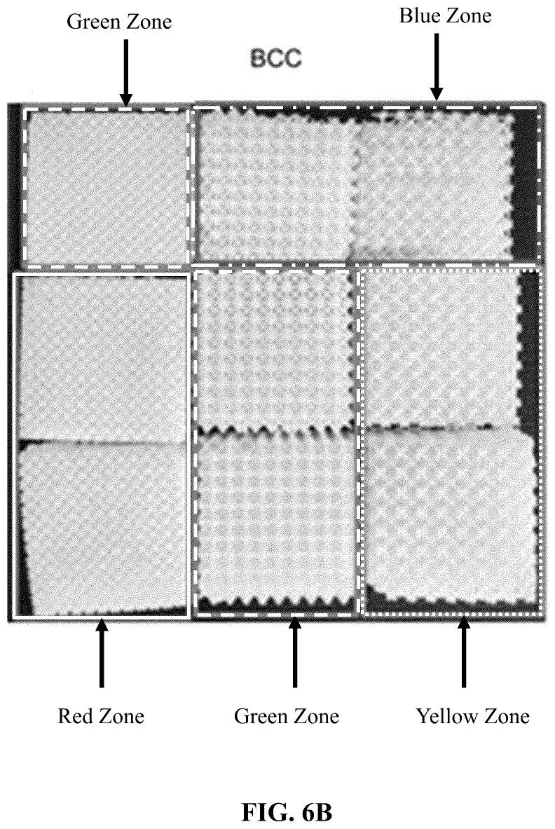

Based on the constraints found, a printability test was performed. The results were divided into four zones (FIGS. 6A (Kelvin) and 6B (BCC)). Red zone presents clogged meshes indicating that the machine was not able to print the configuration. The blue zone presents meshes that are too weak and cannot support the pressures applied when removing the parts from the machine. The yellow zone presents meshes with high porosities, resulting in bad superficial qualities. Finally, the green zone represents the mesh configurations that showed promising capabilities to work as part of the molds.

### Architecture of Integrated Molds

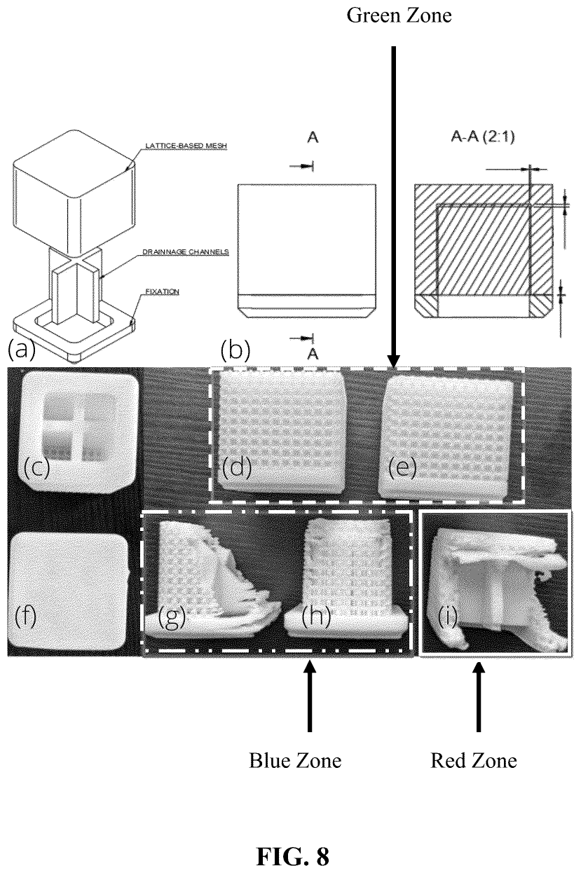

A sample mold that includes the three most important design features (i.e., lattice-based mesh, drainage channels, fixation base), presented in FIG. 8A, was designed to perform this test. FIG. 8B shows the intersection among different components, joining the structure into one integrated mold.

The following problems were encountered during the fabrication of molds: failed prints due to attachment problems between the different components; broken meshes due to an incorrect relationship between unit cell size and mesh thickness; broken meshes at the moment of removing the printing supports; and broken meshes due to an unsupported scaffold for the lattice-based mesh.

The green zone presents the samples with interference between the lattice-based mesh and the other components. On the contrary, the sample in the red zone has a 0 [mm] interference. These results show that interference between components enhances printability. The blue zone presents meshes with thicknesses of h, (right) and h/2 (left). Meanwhile, the green zone had 2 h mesh thickness. FIGS. 8C-8I shows results of printability test. FIG. 8C shows that a gap between the drainage channels and the fixation base made the supports break by themself and stay in the machine's building plate. In contrast, FIG. 8F shows that a gap was sealed due to an attachment of the supports and the base. Based on these results, the following design rules were engineered: The lattice-based mesh must have a thickness defined by equation 3.

T≥2·h (3)

where T, represents the minimum lattice-based mesh thickness, and h represents the unit cell size.

An interference between each component functions to ensure correct printability. A 5 [mm] gap should be left between the fixation base and drainage channels. Squared drainage channels with an inner thickness of 10 [mm] and a wall thickness of 2.5 [mm] functions to ensure the correct printing for lattice scaffolding.

### Industrial Validation

Two industrial pilots were conducted to validate the mold's functionality under industrial conditions. These tests were executed in facilities from the IMFA and a molded pulp industrial facility in Denmark, both run in prototyping machinery. The parameters of the machine used by the IMFA are presented in TABLE 1.

### Industrial Pilot 1

The first pilot had the objective of empirically evaluating the mold's performance. The manufacturers tested the number of cycles the mold was able to withstand. Briefly, the test used a thick wall molded fiber process. Therefore, only a forming mold was used. After the forming stage, the molded fiber resulting part was inserted into a thermoforming mold to dry and refine the resulting superficial quality. As a result, the molds ran more than 100 cycles without failing. In addition, during this test, there were no signs of clogging due to fiber retention nor presented. corrosion, degradation, or calcification, a common problem for stainless steel meshes. These results, plus the fatigue property analysis of the mesh, allow the researchers to expect a lifespan of at least 1,000 cycles per mold.

However, the mold's external drainage channels showed a critical reduction in the suction pressure at the highest zones of the molds. This pressure reduction is an effect of the larger suction area of external drainage channels compared to internal drainage channels. As a result, the borders of the upper zone of the MFP were thinner and weaker. To maintain an even pressure through the mold's drainage channels, and therefore an even fiber thickness, pressure leveling holes were added to the highest point of the drainage channels.

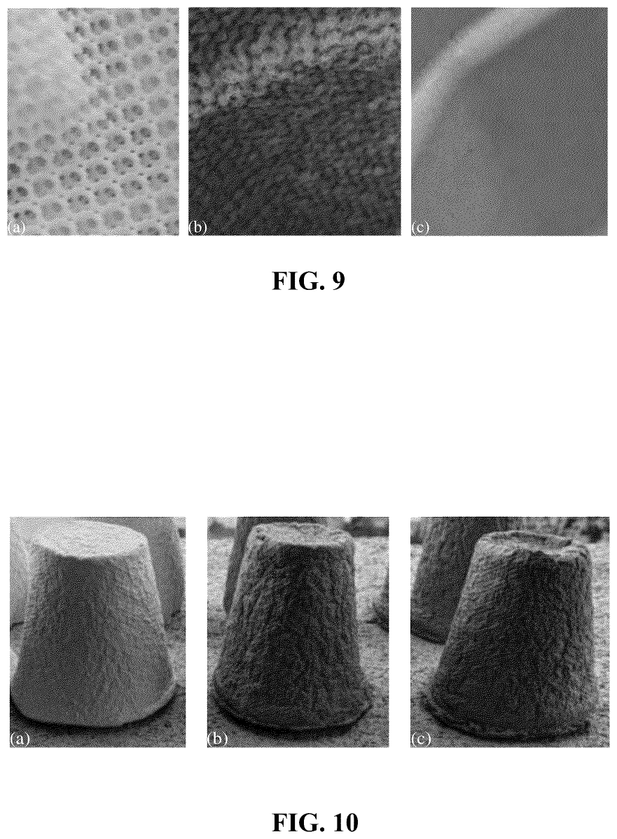

In addition, a qualitative analysis of the superficial quality of the resulting MFP was conducted. The mesh had a porosity of 0.79%, based on equation 1. The study showed the need to reduce the porosity of the mold to get smoother superficial quality. It also proved that the superficial quality could be improved using thermoforming. The results are shown in FIGS. 94-9C. Specifically, FIG. 9B shows the rough finish that through thermoforming became smooth as shown in FIG. 9C.

This pilot validated the mold under industrial conditions. The MFP superficial quality presented in FIG. 9B shows that the porosity calculation of equation 1 allowed to determine the lattice structure's printability and behavior over several layers of lattice material. However, it does not work to define the resulting MTP's superficial quality. Therefore, it does not provide an accurate comparison with stainless-steel meshes. Accordingly, an analysis of the external layer of the mesh can be used for the comparison, as this layer defines the porosity of the zone in direct contact with the resulting MFP. In FIG. 9A, it was observed that the porosity of the outer layer of the mesh was defined mainly by the unit cell size and strut thickness. As a result, equation 4 is defined:

P=h−s (4)

where the porosity (P) is defined by the unit cell size (h) and the strut diameter (s). For the mesh configuration presented in x′2 and used in this pilot, the resulting porosity calculated using equation 4 was 2 [mm], in contrast with 0.79% obtained with equation 1. Furthermore, equation 3 measures porosity in length scales, comparable to current industry-standard measuring systems (U.S.Mesh).

### Industrial Pilot 2

The objective of this test was to analyze the functional properties of the mold with a broader range of fiber lengths. This test used a transfer molding process. Therefore, a forming mold and a transfer mold were tested. While the pi lot with IMFA had the objective to evaluate the functionality of the molds through different fiber lengths. The characterization was conducted using two fibers; sugar cane fiber, with lengths ranging from 25-200 [mm], and recycled office paper fibers, ranging from 2-4 [mm]. Both tests were done using a 99:1 ratio slurry. The prototyping machine's mechanical characteristics are presented in TABLE 1.

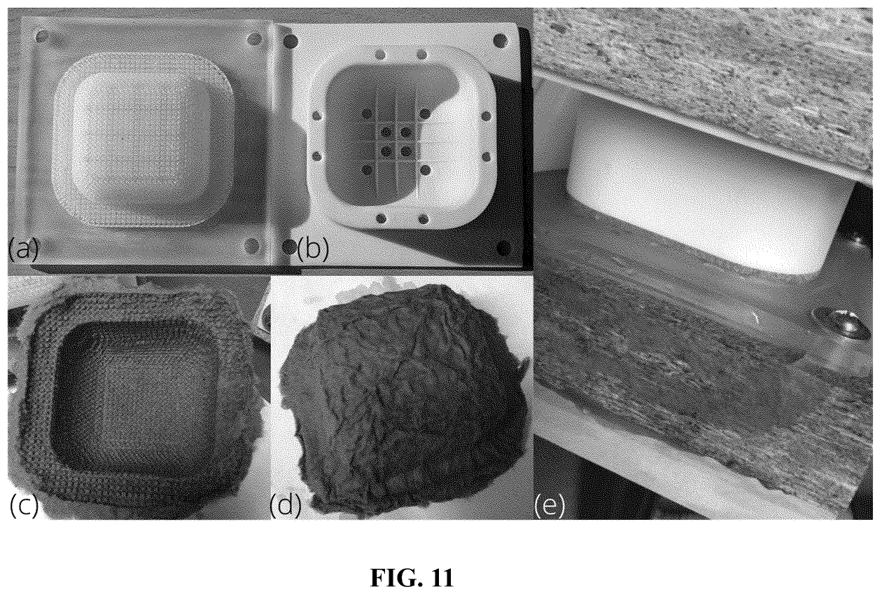

During this test, the molds presented optimal functionality for fibers ranging from 2-40 [mm], covering a wider range of natural fibers used by the molded pulp industry. The results are presented in FIG. 10A for short fibers and FIG. 10B for long fibers. They can be contrasted with the results obtained using a standard stainless-steel mesh mold, FIG. 10C. The experiment was done using a prototyping machine. Therefore, the quality results of this machine are not comparable to industrial machinery. FIGS. 11A-11E shows an example of the tooling presented in this research assembled into the prototyping machine.

An analysis of results of the experiment provided herein indicates the functionality of lattice structures as filters for solid particles with lengths bigger than 2 [mm]. The analysis further indicates that porosity constraints are defined by the machine's resolution, not by the computational design workflow.

1-4. (canceled)

5. A method for designing an integrated mold, comprising:
(a) creating a digital representation of the integrated mold;
(b) deconstructing the integrated mold into an architecture, wherein the architecture includes the following components:
a drainage channel,
a porous mesh,
optionally, a fixation base, and
optionally, a sealing wall;
(c) designing the porous mesh;
(d) printing the components; and
(e) assembling the components into the integrated mold.

6. The method of claim 5, wherein the porous mesh is designed based on input parameters selected from lattice cellular structure, unit cell distribution, and lattice thickness.

7. The method of claim 5, further comprising using one or more additive manufacturing methods for making the components before assembling the components into the integrated mold.

8. A method of manufacturing a 3D printed mesh for filtering fibers from a slurry, the method comprising:
selecting a mesh with a lattice cellular structure based on one or more input parameters; and
optionally, using one or more additive manufacturing methods for making the mesh,
wherein the one or more input parameters comprise unit cell topology, unit cell size, strut diameter, mesh resolution, blend distance, or combinations thereof.

9. The method of claim 8, wherein the one or more additive manufacturing methods comprise stereolithography (SLA), FDM, SLS and MJF.

10. The method of claim 9, wherein the additive manufacturing method is SLA.

11. The method of claim 10, further comprising curing the 3D printed mesh with UV light.

12. The method of claim 10, further comprising sanding the 3D printed mesh.

13. A 3D printed mesh for filtering fibers from a slurry, the 3D printed mesh comprising a polymer having a lattice topology.

14. The 3D printed mesh of claim 13, wherein the lattice topology comprises a Kelvin topology, a grid topology, a yin tiles topology, an isotruss topology, or a body centered cubic (BCC) topology.

15. The 3D printed mesh of claim 13, wherein the lattice topology has a unit cell size of from about 2.0 mm to about 3.0 mm.

16. The 3D printed mesh of claim 15, further comprising struts.

17. The 3D printed mesh of claim 16, wherein the struts are from about 0.3 mm to about 0.5 mm in diameter.

18. The 3D printed mesh of claim 13, wherein the polymer is acrylonitrile butadiene styrene (ABS) or polyamides.

19. The 3D printed mesh of claim 13, wherein the polymer further comprises glass.

20. A molded fiber product formed using the 3D printed mesh of claim 13.

21. An integrated mold architecture comprising at least two components that are attached to each other, wherein the at least two components comprise:
the 3D printed mesh of claim 13;
a drainage channel;
optionally, a fixation base; and
optionally, a sealing wall.

22. A molded fiber product formed using an integrated mold architecture, wherein the integrated mold architecture comprises at least two components that are attached to each other, wherein the at least two components comprise:
the 3D printed mesh of claim 13;
a drainage channel;
optionally, a fixation base; and
optionally, a sealing wall.
